(19) United States
(12) Patent Application Publication
(10) Pub. No.: US 2017/0283298 A1
(43) Pub. Date: Oct. 5, 2017

(54) LASER SINTERING SYSTEM AND METHOD FOR FORMING HIGH PURITY, LOW ROUGHNESS, LOW WARP SILICA GLASS

(71) Applicant: Corning Incorporated, Corning, NY (US)

(72) Inventors: Daniel Warren Hawtof, Corning, NY (US); Xinghua Li, Horseheads, NY (US); Kathleen Elizabeth Morse, Painted Post, NY (US)

(21) Appl. No.: 15/492,558

(22) Filed: Apr. 20, 2017

Related U.S. Application Data
(63) Continuation of application No. PCT/US17/24017, filed on Mar. 24, 2017.
(60) Provisional application No. 62/312,730, filed on Mar. 24, 2016.

(51) Int. Cl. C03B 19/06; C03B 19/14

(52) U.S. Cl. CPC C03B 19/06; C03B 19/14; C03B 19/1492

(57) ABSTRACT

A system and method for making a thin sintered silica sheet is provided. The method includes providing a soot deposition surface and forming a glass soot sheet by delivering a stream of glass soot particles from a soot generating device to the soot deposition surface. The method includes providing a sintering laser positioned to direct a laser beam onto the soot sheet and forming a sintered glass sheet from the glass soot sheet by delivering a laser beam from the sintering laser onto the glass soot sheet. The sintered glass sheet formed by the laser sintering system or method is thin, has low surfaces roughness and/or low contaminant levels. The system is also configured to produce a sheet having low degrees of warp and/or low fictive temperatures.

This application is a continuation of International Patent Application Serial No. PCT/US17/24017, filed on Mar. 24, 2017, which claims the benefit of priority under 35 U.S.C. §119 of U.S. Provisional Application Ser. No. 62/312,730, filed on Mar. 24, 2016, the contents of which are relied upon and incorporated herein by reference in their entireties.

### BACKGROUND

The disclosure relates generally to formation of silica-containing articles, and specifically to the formation of thin silica glass sheets. Silica soot may be generated by a process, such as flame hydrolysis. The silica soot may then be sintered to form a transparent or partially transparent glass sheet.

### SUMMARY

One embodiment of the disclosure relates to a method for making a thin sintered silica sheet. The method includes providing a soot deposition surface and forming a glass soot sheet by delivering a stream of glass soot particles from a soot generating device to the soot deposition surface. The method includes providing a sintering laser positioned to direct a laser beam onto the glass soot sheet and moving at least one of the glass soot sheets and the laser beam relative to the other. The method includes forming a sintered glass sheet from the glass soot sheet by delivering a laser beam from the sintering laser onto the glass soot sheet. The sintered glass sheet has an average thickness and an as-sintered average warp, and the average thickness of the sintered glass sheet is less than 500 μm. The method includes applying a force to the sintered glass sheet to form a flattened glass sheet, and the flattened glass sheet has a low average warp, such as less than the as-sintered average warp.

An additional embodiment of the disclosure relates to a high purity sintered silica glass sheet. The silica glass sheet includes a first major surface, a second major surface opposite the first major surface and at least 99.9 mole % silica. The silica glass sheet includes an average thickness between the first major surface and the second major surface of less than 500 μm and an average warp of less than 1 mm over at least one area of 2500 mm². A roughness (Ra) of the first major surface is between 0.025 nm and 1 nm over at least one 0.023 mm² area of the first major surface.

An additional embodiment of the disclosure relates to high purity sintered silica glass sheet. The silica glass sheet includes a first major surface, a second major surface opposite the first major surface and at least 99.9 mole % silica. The silica glass sheet includes an average thickness between the first major surface and the second major surface of less than 500 μm and a fictive temperature of less than 1400 degrees C.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 shows a laser sintering system according to an exemplary embodiment.

FIG. 2 shows a laser sintering system according to another exemplary embodiment.

FIG. 3 shows a laser sintering system according to another exemplary embodiment.

FIG. 4 shows a laser sintering system according to another exemplary embodiment.

FIG. 5 shows the output from a Zygo optical profiler measuring the surface of a laser sintered silica glass sheet formed via laser sintering according to an exemplary embodiment.

FIG. 6 shows the output from a Zygo optical profiler measuring the surface of a laser sintered silica glass sheet formed via laser sintering according to another exemplary embodiment.

FIG. 7 is a 3D micro-scale representation of a measured profile of a surface of a laser sintered silica glass sheet formed via laser sintering according to an exemplary embodiment.

FIG. 8A-8C are atomic force microscopy profile scans of the glass sheet surface shown in FIG. 7 according to an exemplary embodiment.

FIG. 9 shows a comparative output from a Zygo optical profiler measuring the surface of a non-laser sintered silica material following surface polishing.

FIG. 10 shows magnified surface images surfaces of laser sintered silica glass sheets formed via various laser sintering processes according to exemplary embodiments.

FIG. 11 is a cross-sectional view showing an edge section of a laser cut out subsection of a laser sintered silica glass sheet formed via laser sintering according to an exemplary embodiment.

FIG. 12 is a perspective view of a flattening system according to an exemplary embodiment.

FIG. 13 is a perspective view of the flattening system of FIG. 12 following placement of a top plate according to an exemplary embodiment.

FIG. 14 is a perspective view of the flattening system of FIG. 12 during heating according to an exemplary embodiment.

FIG. 15 is a perspective view of the flattening system of FIG. 12 following removal of a top plate and following flattening of a sintered glass sheet according to an exemplary embodiment.

FIG. 16 shows output from a Zygo optical profiler measuring the contact surfaces of the upper and lower plates of the flattening system of FIG. 12, according to an exemplary embodiment.

FIG. 17 shows a measurement of TIR, Wa and Wt of a low warp sintered silica sheet according to an exemplary embodiment.

FIG. 18 depicts calculation of warp of a sheet according to an exemplary embodiment.

FIG. 19 is a plot showing laser transmission as a function of wavelength for a silica soot sheet and a sintered silica sheet according to an exemplary embodiment.

### DETAILED DESCRIPTION

Referring generally to the figures, various embodiments of a sintered silica glass sheet/material as well as related systems and methods are shown. In various embodiments, the system and method disclosed herein utilizes one or more glass soot generating device (e.g., a flame hydrolysis burner) that is directed or aimed to deliver a stream of glass soot particles on to a soot deposition device or surface forming a glass soot sheet. The soot sheet is then sintered using a laser forming a silica glass sheet. In general, the laser beam is directed onto the soot sheet such that the soot densifies forming a fully sintered or partially sintered silica glass sheet. In various embodiments, the configuration and/or operation of the glass soot generating device, the soot deposition surface and/or the sintering laser are configured to form a sintered glass sheet having very high surface smoothness as compared to some sintered silica glass sheets formed from sintered silica soot (e.g., as compared to furnace and torch processes, and some other laser sintering processes). In some embodiments, the glass sheet formation process discussed herein forms a silica glass sheet having surface characteristics that are distinct from the surface characteristic of a polished silica surface such a polished, silica boule surface.

Further, the configuration and/or operation of the glass soot generating device, the soot deposition surface and/or the sintering laser are configured to form a sintered glass sheet having very low levels of certain contaminants (e.g., sodium (Na), surface hydroxyl groups, etc.) commonly found in silica materials formed using some other methods. Applicant has found that by using the laser sintering process and system discussed herein, sintered silica glass sheets can be provided with a high surface smoothness and low contaminant content without requiring additional polishing steps in some embodiments.

In further additional embodiments, sintered silica glass sheets discussed herein have a thickened or bulb shaped edge section that is formed by using a high powered cutting laser to cut out a section from the sintered silica glass sheet. This cut section can then be used in various ways as desired (e.g., a substrate for various devices and processes). The thickened edge section defines the outer perimeter of the cut silica glass sheet, and Applicant has found results in a silica sheet with various improved physical characteristics, such as improved strength characteristics.

In yet additional embodiments, sintered silica glass sheets discussed herein also include a high level of flatness (e.g., a low degree of warp, as discussed below), even in very thin sheets. In various embodiments, the high level of flatness is achieved through a flattening process in which a sintered silica glass sheet having a relatively high degree of warp is heated and then is flattened through application of a force, such as force provided between upper and lower silica plates. Applicant has identified that having a relatively high roughness of the plate surfaces touching the silica sheet limits or prevents bonding between the silica plates and the sintered silica glass sheet. In addition, Applicant has identified that heating the sintered silica glass sheet to the temperature ranges discussed herein allow for flattening while at the same time maintaining the low surface roughness despite contact with the relatively rough silica plate surfaces. Further, Applicant has found that using high purity silica plates during flattening maintains the high purity of the sintered silica glass sheets discussed herein. Thus, Applicant believes that the sintered silica glass sheets discussed herein provide a combination of thinness, low warp, purity and/or low surface roughness not believed to be achievable with conventional silica formation methods.

In yet other embodiments, the high level of flatness of the sintered silica glass sheets discussed herein is achieved via controlling one or more parameter during sintering. In particular, Applicant believes that high flatness may be achieved during sintering by controlling sintering laser energy, sintering laser shape, tension on the soot sheet during sintering, spatial orientation of the soot sheet during sintering, soot density/thickness profiles, etc. Further, control of various sintering parameters, such as sintering laser wavelength, results in formation of sintered silica sheets having particularly low fictive temperature and/or a low fictive temperature gradient through the thickness of the sintered silica glass sheets. Applicant believes that the fictive temperature properties discussed herein may provide a sintered glass sheet with various beneficial characteristics including increased strength.

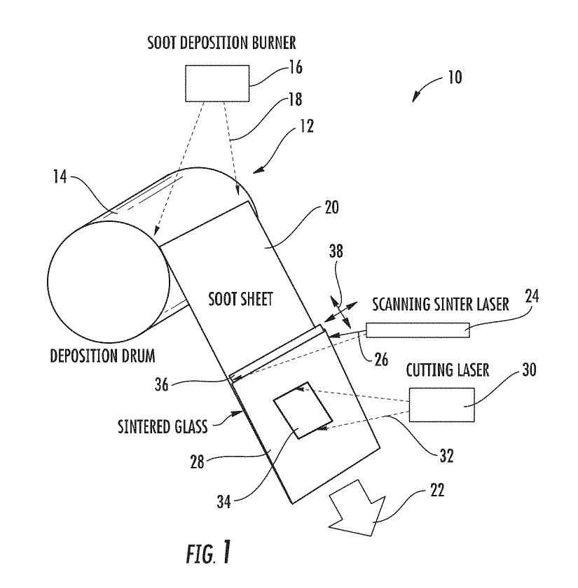

Referring to FIG. 1, a system and method for forming a high purity, high smoothness silica glass sheet is shown according to an exemplary embodiment. As shown in FIG. 1, system 10 includes a soot deposition device, shown as deposition drum 12, having an outer deposition surface 14. System 10 includes a soot generating device, shown as soot burner 16 (e.g., a flame hydrolysis burner), that directs a stream of glass soot particles 18 onto deposition surface 14 forming glass soot sheet 20.

As shown in FIG. 1, drum 12 rotates in the clockwise direction such that soot sheet 20 is advanced off of drum 12 in a processing direction indicated by the arrow 22 and advanced past sintering laser 24. In some embodiments, soot sheet 20 is in tension (e.g., axial tension) in the direction of arrow 22. In specific embodiments, soot sheet 20 is only in tension (e.g., axial tension) in the direction of arrow 22 such that tension is not applied widthwise across soot sheet 20. Applicant was surprised to identify that widthwise tensioning of the soot sheet during sintering was not needed to maintain the surface characteristics, specifically roughness, discussed herein. However, in at least some other embodiments, soot sheet 20 is tensioned in the widthwise direction. In some embodiments, tensioning in different directions is selected to control the bow or warp of the sintered soot sheet.

As will be explained in more detail below, sintering laser 24 generates a laser beam 26 toward soot sheet 20, and the energy from laser beam 26 sinters glass soot sheet into a partially or fully sintered glass sheet 28. As will be understood, the energy from sintering laser beam 26 causes the densification of glass soot sheet 20 into a partially or fully sintered glass sheet 28. Specifically, laser sintering of silica soot sheet 20 uses laser 24 to rapidly heat soot particles to temperatures above the soot melting point, and as a result of reflow of molten soot particles a fully dense, thin silica glass sheet 28 is formed. In various embodiments, soot sheet 20 has a starting density between 0.2 g/cc to 0.8 g/cc, and silica glass sheet 28 is a fully sintered silica glass sheet having a density of about 2.2 g/cc (e.g., 2.2 g/cc plus or minus 1%). As will be explained in more detail below, in some embodiments, silica glass sheet 28 is a fully sintered silica glass sheet including voids or bubbles such that the density of the sheet is less than 2.2 g/cc. In various other embodiments, soot sheet 20 has a starting density between 0.2 g/cc to 0.8 g/cc, and silica glass sheet 28 is a partially sintered silica glass sheet having a density between 0.2 g/cc and 2.2 g/cc. In various embodiments, sintered glass sheet 28 has length and width between 1 mm and 10 m, and in specific embodiments, at least one of the length and width of sintered glass sheet 28 is greater than 18 inches. It is believed that in various embodiments, system 10 allows for formation of sintered glass sheet 28 having length and/or width dimensions greater than the maximum dimensions of silica structures formed by other methods (e.g., silica boules which are typically limited to less than 18 inches in maximum dimension).

System 10 is configured to generate a soot sheet 20 having a smooth surface topology which translates into glass sheet 28 also having a smooth surface topology. In various embodiments, soot burner 16 is positioned a substantial distance from and/or at an angle relative to drum 12 such that soot streams 18 form a soot sheet 20 having a smooth upper surface. This positioning results in mixing of soot streams 18 prior to deposition onto surface 14. In specific embodiments, the outlet nozzles of soot burner 16 are positioned between 1 inch and 12 inches, specifically 1 inch to 4 inches, and more specifically about 2.25 inches, from deposition surface 14, and/or are positioned at a 30-45 degree angle relative to soot deposition surface 14. In specific embodiments, soot stream 18 can be directed to split above and below drum 12 with exhaust, and in other embodiments, soot stream 18 is directed only to one side of drum 12. In addition, the velocity of soot streams 18 leaving burner 16 may be relatively low facilitating even mixing of soot streams 18 prior to deposition onto surface 14. Further, burner 16 may include a plurality of outlet nozzles, and burner 16 may have a large number of small sized outlet nozzles acting to facilitate even mixing of soot streams 18 prior to deposition onto surface 14. In addition, burner 16 may be configured to better mixing of constituents and soot within channels inside the burners such as via a venturi nozzle and flow guides that generate intermixing and eddies. In some embodiments, these structures may be formed via 3D printing.

In various embodiments, laser 24 is configured to further facilitate the formation of glass sheet 28 having smooth surfaces. For example in various embodiments, sintering laser 24 is configured to direct laser beam 26 toward soot sheet 20 forming a sintering zone 36. In the embodiment shown, sintering zone 36 extends the entire width of soot sheet 20. As will be discussed in more detail below, laser 24 may be configured to control laser beam 26 to form sintering zone 36 in various ways that results in a glass sheet 28 having smooth surfaces. In various embodiments, laser 24 is configured to generate a laser beam having an energy density that sinters soot sheet 20 at a rate that forms smooth surfaces. In various embodiments, laser 24 generates a laser beam having an average energy density between 0.001 J/mm² and 10 J/mm², specifically 0.01 J/mm² and 10 J/mm², and more specifically between 0.03 J/mm² and 3 J/mm² during sintering. In some embodiments, laser 24 may be suited for sintering particularly thin soot sheets (e.g., less than 1000 μm, less than 500 μm, less than 200 μm, 100 μm, 50 μm, etc. thick), and in such embodiments, laser 24 generates a laser beam having an average energy density between 0.001 J/mm² and 0.01 J/mm². In other embodiments, system 10 is configured such that relative movement between soot sheet 20 and laser 24 occurs at a speed that facilitates formation of glass sheet 28 with smooth surfaces. In general, the relative speed in the direction of arrow 22 is between 0.1 mm/s and 10 m/s. In various embodiments, the relative speed in the direction of arrow 22 is between 0.1 mm/s and 100 mm/s, specifically between 0.5 mm/s and 5 mm/s, and more specifically between 0.5 mm/s and 2 mm/s. In various embodiments, system 10 is a high speed sintering system having a relative speed in the direction of arrow 22 between 1 m/s and 10 m/s.

As shown in FIG. 1, in one embodiment, laser 24 utilizes dynamic beam shaping to form sintering zone 36. In this embodiment, laser beam 26 is rapidly scanned over soot sheet 20 generally in the direction of arrows 38. The rapid scanning of laser beam 26 emulates a line-shaped laser beam generally in the shape of sintering zone 36. In a specific embodiment, laser 24 utilizes a two-dimensional galvo scanner to scan laser beam 26 forming sintering zone 36. Using a two-dimensional galvo scanner, laser beam 26 can be rastered across the entire width of soot sheet 20 or across a specific subarea of soot sheet 20. In some embodiments, laser beam 26 is rastered as soot sheet 20 is translated in the direction of arrow 22. During the sintering process the rastering speed may vary depending on the desired sintering characteristics and surface features. In addition, the rastering pattern of laser beam 26 may be linear, sinusoidal, uni-directional, bidirectional, zig-zag, etc., in order to produce sheets with designed and selected flatness, density or other attributes. In such embodiments, laser 24 may use galvo, polygonal, piezoelectric scanners and optical laser beam deflectors such as AODs (acousto-optical deflectors) to scan laser beam 26 to form sintering zone 36. In various embodiments, relative movement between soot sheet 20 and laser beam 26 may be accomplished via directing laser beam 26 with or without moving laser 24.

In a specific embodiment using a dynamic laser beam shaping to form sintering zone 36, a CO₂ laser beam was scanned bi-directionally at a speed of 1500 mm/s. The CO₂ laser beam has a Gaussian intensity profile with 1/e² diameter of 4 mm. The step size of the bi-directional scan was 0.06 mm. At settings of scan length of 55 mm and a laser power of 200 W, a soot sheet 20 of roughly 400 μm in thickness was sintered into a silica glass sheet 28 of ˜100 μm thickness. The effective sintering speed was ˜1.6 mm/s, and the sintering energy density was 0.65 J/mm². In other embodiments, as discussed below, the sintering laser is a CO laser.

In some embodiments, the dynamic laser beam shaping and sintering approach enables laser power modulation on-the-fly while the laser beam is scanned. For example, if the scanning laser beam has a sinusoidal speed profile, a controller can send a sinusoidal power modulation signal to the laser controller in order to maintain a constant laser energy density on soot sheet 20 within sintering zone 36.

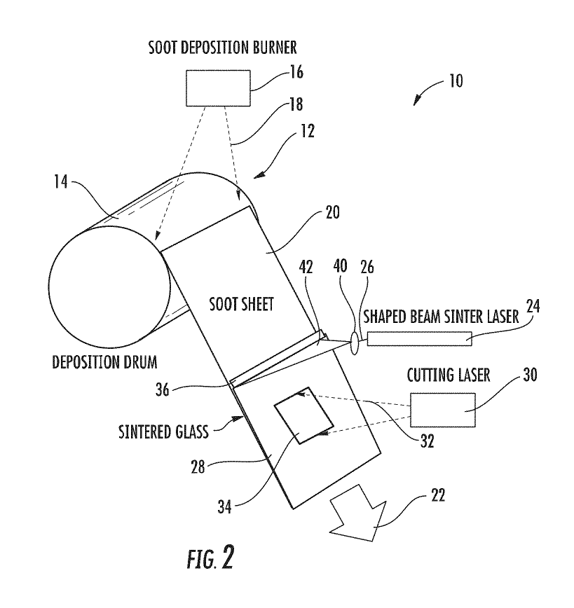

As shown in FIG. 2, in one embodiment, laser 24 utilizes a geometrical/diffractive approach to beam shaping to form sintering zone 36. In this embodiment, laser 24 is utilized in combination with a shaping system 40 to transform laser beam 26 into an elongate laser beam 42. In various embodiments, shaping system 40 may include one or more optical element, such as lenses, prisms, mirrors, diffractive optics, etc. to form elongate laser beam 42. In various embodiments, elongate laser beam 42 has a uniform intensity distribution in the width direction across soot sheet 20. In various embodiments, shaping system 40 may be configured to generate an elongate laser beam 42 having a width between 1 mm and 10 m, and a height between 0.1 mm and 10 mm.

In a specific embodiment using geometrical/diffractive laser beam shaping to form sintering zone 36, a CO₂ laser beam of 12 mm in diameter was expanded using a beam expander of Galilean design. The expanded laser beam is about 50 mm in diameter. The expanded laser beam was then transformed into a line shape using an asymmetric aspheric lens with a focal length of ˜300 mm. The line-shaped laser beam has a dimension of 55 mm×2 mm. The laser power density, which is defined as laser power divided by area, is 1.8 W/mm². During the sintering process, the line-shaped laser beam is kept stationary while soot sheet 20 was translated. At a laser power of 200 W, a soot sheet 20 of roughly 400 μm in thickness was sintered into a silica glass sheet 28 of ˜100 μm thickness at a speed of 1.5 mm/s. The corresponding energy density for sintering is 1.0 J/mm².

In various embodiments, laser 24 can be a laser at any wavelength or pulse width so long as there is enough absorption by the soot particles to cause sintering. The absorption can be linear or nonlinear. In a specific embodiment, laser 24 is a CO₂ laser. In another embodiment, laser 24 may be a CO laser with a wavelength of around 5 μm. In such embodiments, a CO laser 24 can penetrate deeper into soot sheet 20, and thus a CO laser 24 may be used to sinter thicker soot sheets 20. In various embodiments, the penetration depth of a CO₂ laser 24 in silica soot sheet 20 is less than 10 μm, while the penetration depth of the CO laser is ˜100 μm. In some embodiments, soot sheet 20 may be pre-heated from the backside and/or front side, for example, using a resistive heater, an IR lamp, etc., to further increase the depth of sintering formed via laser 24.

In some embodiments, system 10 is configured to maintain a constant sintering temperature during the laser sintering process. This can be achieved by adding temperature sensors along the sintering line. The temperature sensor data can be used to control the laser power in order to maintain constant sintering temperature. For example, a series of germanium or silicon detectors can be installed along the sintering line. The detector signals are read by a controller. The controller can process the signals and use the info to control the laser output power accordingly.

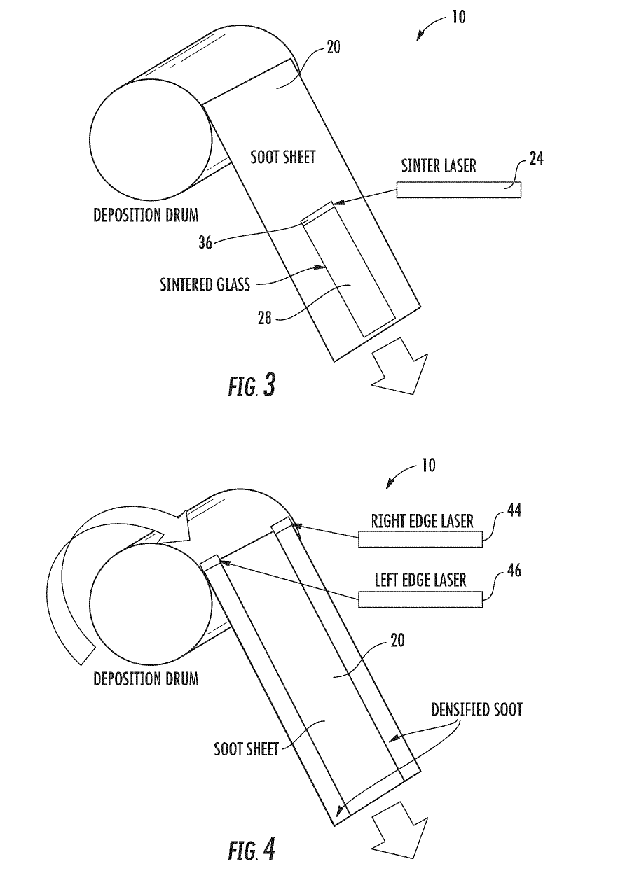

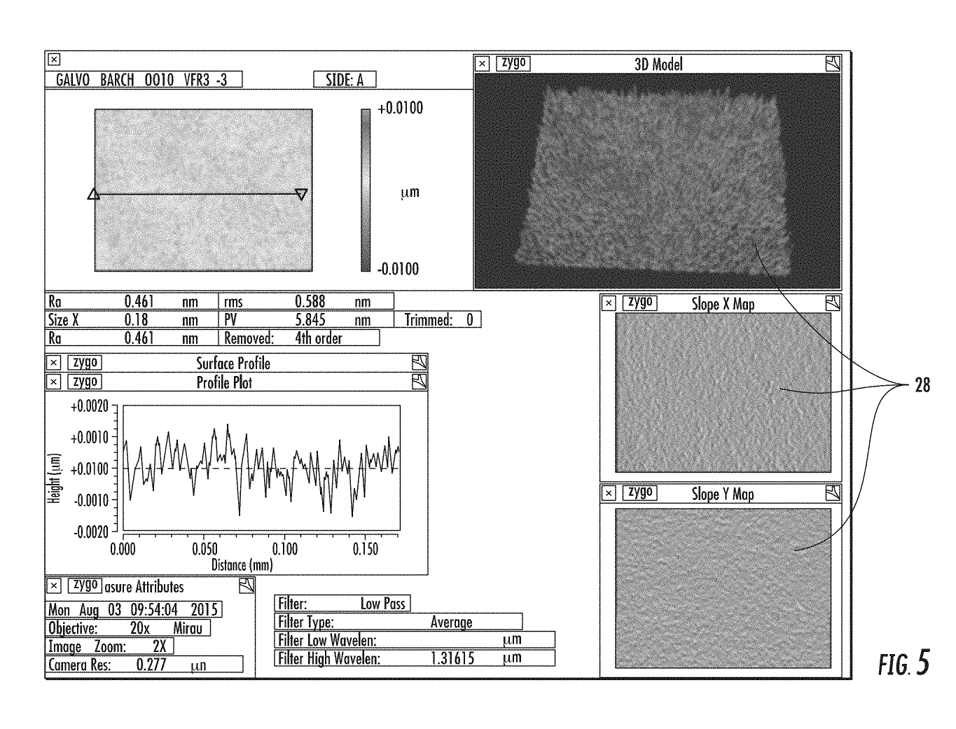

Referring to FIG. 3, in one embodiment, laser 24 may be configured to generate sintering zone 36 that does not extend the entire width of soot sheet 20. In some such embodiments, the smaller sintering zone 36 may result in lower unintended heating of equipment adjacent laser 24 and/or soot sheet 20. Referring to FIG. 4, in various embodiments, system 10 may include additional lasers 44 and 46 that are configured to fully or partially sinter edge portions of soot sheet 20. This may facilitate handling of soot sheet 20 during laser sintering to form sintered sheet 28.

In contrast to some silica glass formation processes (e.g., boule formation processes), system 10 is configured to produce silica glass sheet 28 having very high purity levels with very low thicknesses. In various embodiments, silica glass sheet 28 has a thicknesses (i.e., the dimension perpendicular to the major and minor surfaces) of less than 500 μm, of less than 250 μm, of less 150 μm and of less than 100 μm. Further, in various embodiments, silica glass sheet 28 is least 99.9 mole % silica, and specifically at least 99.99 mole % silica. In addition, silica glass sheet 28 is formed having very low levels of contaminant elements common in silica glass formed by other methods. In specific embodiments, silica glass sheet 28 has a total sodium (Na) content of less than 50 ppm. In various embodiments, the sodium content of silica glass sheet 28 is substantially consistent throughout sheet 28 such that the total sodium content is less than 50 ppm at all depths within silica glass sheet 28. This low total sodium content and the even sodium distribution is in contrast to some silica structures (e.g., silica boules) which have higher overall sodium content that varies at different depths within the boule. In various embodiments, it is believed that the low sodium content discussed herein provides glass sheet 28 with optical loss reduction, index of refraction uniformity and chemical purity/non-reactivity as compared to other silica materials with higher sodium content.

In other embodiments, silica glass sheet 28 has a low level of hydroxyl (OH) concentration. In various embodiments, the OH concentration can be controlled to impact the viscosity, refractive properties, and other properties of silica glass sheet 28. In various embodiments, silica glass sheet 28 has a beta OH concentration of less than 0.2 abs/mm (e.g., less than 200 ppm OH), and more specifically of less than 0.12 abs/mm (120 ppm OH). In various embodiments, silica glass sheet 28 has a particularly low concentration of OH, and in such embodiments, beta OH is less than 0.02 abs/mm and more specifically is less than 0.002 abs/mm. In some embodiments, the OH concentration of silica glass sheet 28 formed using laser sintering system 10 is less than the OH concentration of silica material formed using some other formation methods (e.g., plasma sintering, flame sintering and/or sintering process that dry using chlorine prior to sintering). In contrast to some silica materials that utilize a surface treatment with a material such as hydrofluoric acid, silica glass sheet 28 has a low surface halogen concentration and a low surface OH concentration.

In various embodiments, sintered silica glass sheet 28 has a fictive temperature (Tf) that is higher than the Tf of at least some silica materials, such as silica boules. For example, it is believed that at least in some embodiments, sintered silica glass sheet 28 has a fictive temperature between 1100 degrees C. and 2000 degrees C., specifically between 1500 degrees and 1800 degrees C., and more specifically between 1600 degrees C. and 1700 degrees C. In a specific embodiment, sintered silica glass sheet 28 has a fictive temperature of about 1635 degrees C. (e.g., 1635 degrees C. plus or minus 1%), such as relative to fully-annealed such glass. In various embodiments, the fictive temperatures of sintered glass sheet 28 discussed herein are determined utilizing IR spectroscopy based on the ˜1870 cm⁻¹ band as set forth in S.-R. Ryu & M. Tomozawa, Structural Relaxation Time of Bulk and Fiber Silica Glass as a Function of Fictive Temperature and Holding Temperature, 89 J. Am. Ceramic Soc'y 81 (2006), which is incorporated herein by reference in its entirety.

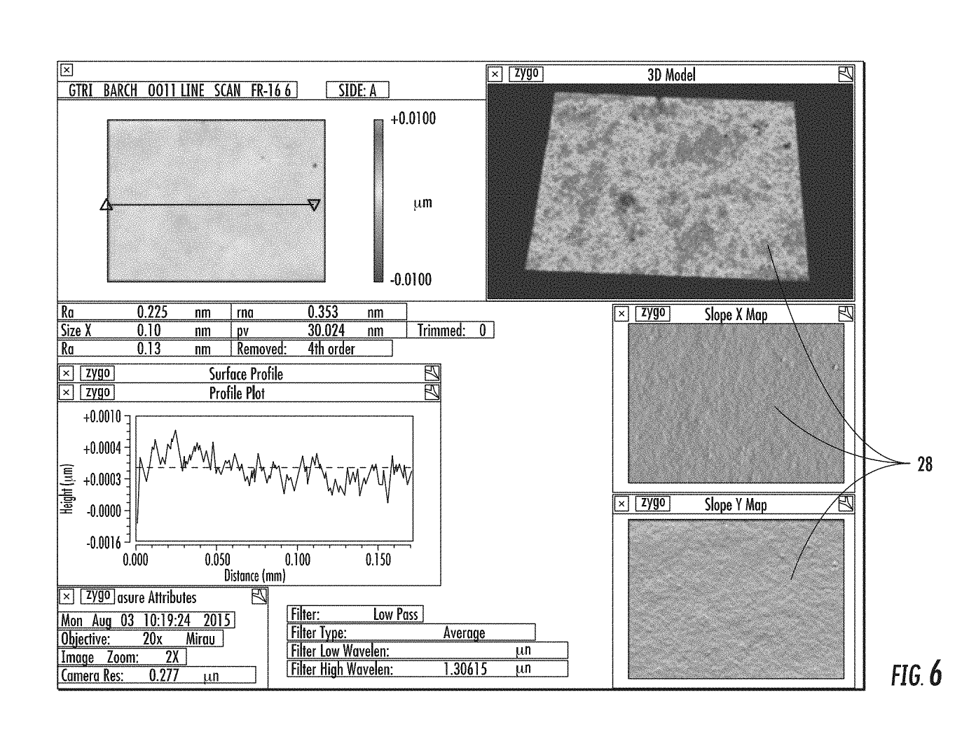

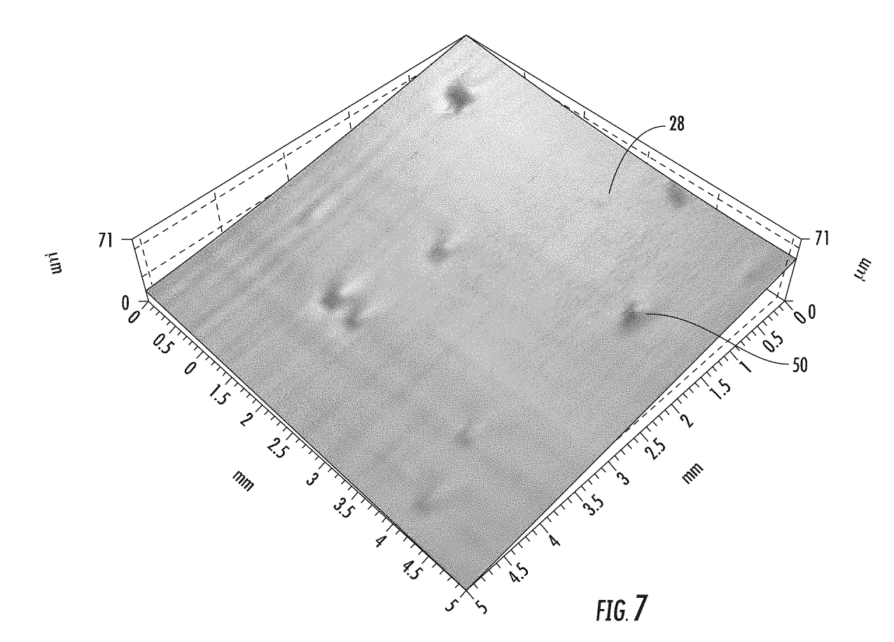

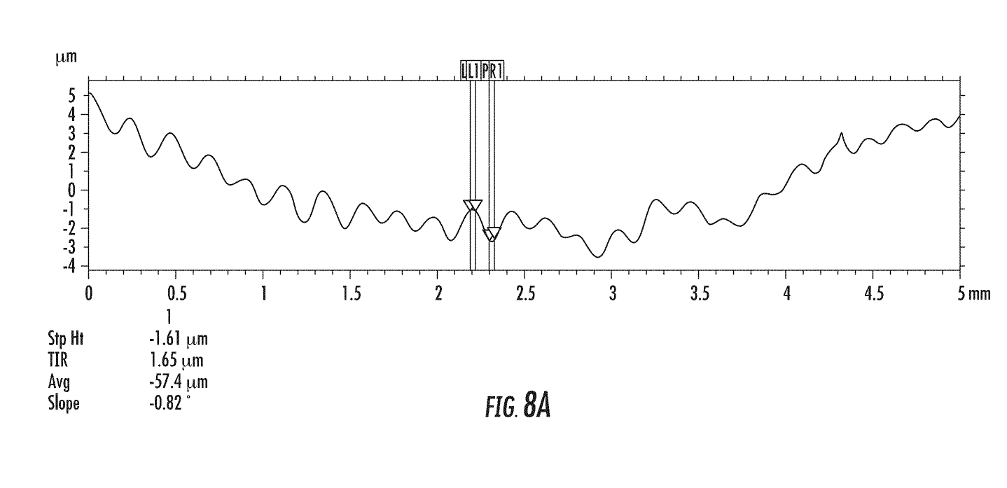

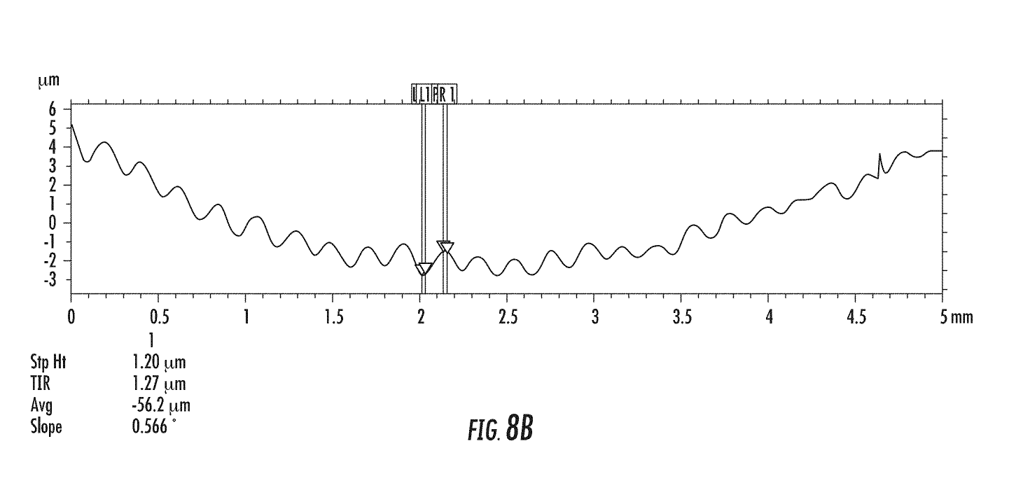

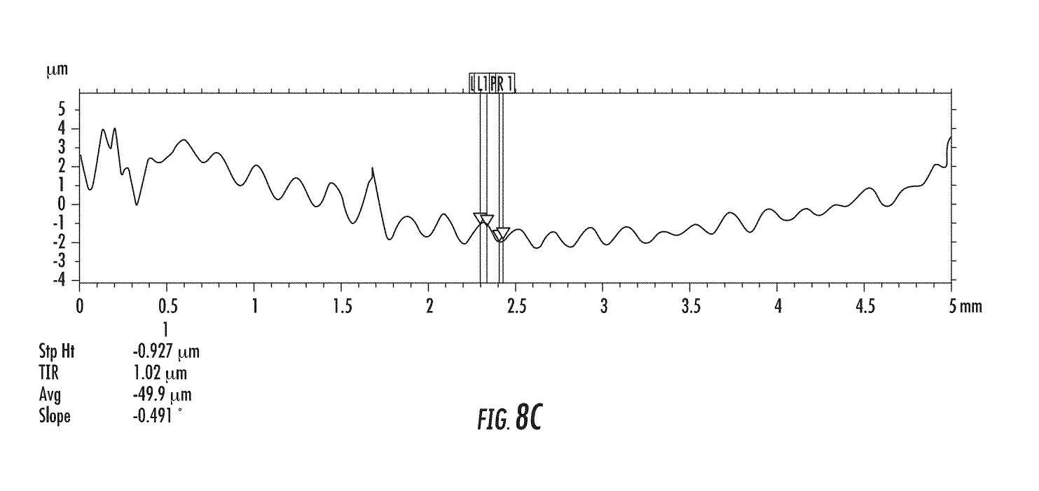

Referring to FIGS. 5-8C, characteristics of the surface profile, topology and roughness of sintered glass sheet 28 are shown according to exemplary embodiments. FIG. 5 shows a Zygo optical profile scan of an embodiment of silica glass sheet 28 formed using a galvo based scanning laser system, such as that shown in FIG. 1. FIG. 6 shows a Zygo optical profile scan of an embodiment of silica glass sheet 28 formed using a geometrical/diffractive laser beam shaping, such as that shown in FIG. 2. FIG. 7 is a 3D micro-scale representation of a measured profile of a surface of an embodiment of silica glass sheet 28 according to an exemplary embodiment. FIGS. 8A-8C show an atomic force microscopy AFM line scans of the surface of the silica glass 28 taken widthwise at three different positions along the length of glass sheet 28 shown in FIG. 7.

In various embodiments, sintered glass sheet 28 has opposing first and second major surfaces, at least one of which has a high level of smoothness. In various embodiments, the roughness (Ra) of at least one of the first major surface and the second major surface of sintered glass sheet 28 is between 0.025 nm and 1 nm, specifically between 0.1 nm and 1 nm and specifically between 0.025 nm and 0.5 nm, over at least one 0.023 mm² area. In particular embodiments, the roughness (Ra) of at least one of the first major surface and the second major surface of sintered glass sheet 28 is particularly low such that the roughness is between 0.025 nm and 0.2 nm over at least one 0.023 mm² area. In one such embodiment, Ra is determined using a Zygo optical profile measurement as shown in FIGS. 5 and 6, and specifically determined using the Zygo with a 130 μm×180 μm spot size. In some embodiments, the roughness (Ra) of at least one of the first major surface and the second major surface of sintered glass sheet 28 is between 0.12 nm and 0.25 nm as measured using AFM over a 2 μm line scan, as shown in FIGS. 8A-8C. In specific embodiments, sintered glass sheet 28 has a low roughness level on a small scale measurement, and a larger roughness level with a larger scale measure. In various embodiments, the roughness (Ra) of at least one of the first major surface and the second major surface of sintered glass sheet 28 is between 0.025 nm and 1 nm over at least one 0.023 mm² area, and an Ra of between 1 μm and 2 μm using a profilometer and a scan length of 5 mm.

As shown in FIGS. 5-8C, while the major surfaces of sintered glass sheet 28 are smooth, the surfaces do have a nanoscale surface topology including series of raised and recessed features. In the embodiments discussed herein, the raised and recessed features are relatively small contributing to the low surface roughness. In various embodiments, each raised feature has a maximum peak height that is between 0.1 μm and 10 μm, and specifically between 1 μm and 2 μm, relative to the average or baseline height of the topology as measured using a profilometer and a scan length of 5 mm. In specific embodiments, the topology of one or more surface of glass sheet 28 is such that the maximum vertical distance between the bottom of a recessed feature (e.g., a valley) and the top of a raised feature (e.g., a peak) is between 1 nm and 100 nm within at least one 0.023 mm² area as measured by a Zygo optical profile measurement. Table 1 shows roughness data from an AFM scan of a surface of a sintered glass sheet 28 according to an exemplary embodiment.

TABLE 1
Roughness Measurements

| | scan | | | | |
|---|---|---|---|---|---|
| Scan No./Sample No. | size | Rq (nm) | Ra (nm) | Skewness | Kurtosis |
| Scan 1 - Sample 1 | 500 nm | 0.164 | 0.131 | −0.00552 | 3.03 |
| Scan 2 - Sample 1 | 500 nm | 0.173 | 0.138 | −0.0925 | 3.08 |
| Scan 3 - Sample 1 | 500 nm | 0.16 | 0.129 | 0.043 | 2.91 |
| Scan 4 - Sample 1 | 500 nm | 0.178 | 0.142 | 0.00239 | 3 |
| Scan 5 - Sample 1 | 500 nm | 0.164 | 0.131 | −0.00533 | 2.97 |
| Scan 6 - Sample 1 | 2 um | 0.219 | 0.174 | 0.0273 | 3 |
| Scan 7 - Sample 1 | 2 um | 0.196 | 0.156 | 0.0218 | 3 |
| Scan 8 - Sample 1 | 2 um | 0.204 | 0.162 | −0.0261 | 3.11 |
| Scan 9 - Sample 1 | 2 um | 0.202 | 0.161 | 0.0227 | 2.96 |
| Scan 1 - Sample 2 | 500 nm | 0.182 | 0.143 | 0.225 | 3.91 |
| Scan 2 - Sample 2 | 500 nm | 0.175 | 0.138 | 0.142 | 3.35 |
| Scan 3 - Sample 2 | 500 nm | 0.181 | 0.142 | 0.424 | 6.09 |
| Scan 4 - Sample 2 | 2 um | 0.215 | 0.167 | 0.685 | 12.1 |
| Scan 5 - Sample 2 | 2 um | 0.223 | 0.172 | 1.07 | 20.4 |
| Scan 6 - Sample 2 | 2 um | 0.231 | 0.179 | 0.705 | 11.1 |

As shown best in FIG. 7, silica glass sheet 28 may include a plurality of voids or bubbles. In various embodiments, some of the voids or bubbles may be located on the surface of silica glass sheet 28, forming depressions 50 shown in FIG. 7, and other bubbles or voids may be located within an internal area of the sintered silica material of silica glass sheet 28. In such embodiments, the bubbles or voids result in sheet 28 having a bulk density less than the maximum density of sintered silica without voids or bubbles. In various embodiments, sintered silica glass sheet 28 is a fully sintered silica sheet (e.g., one with a low amount or no unsintered silica soot particles) that has a density greater than 1.8 g/cc and less than 2.2 g/cc and specifically less than 2.203 g/cc (e.g., the maximum density of fully sintered silica without any voids or bubbles). In such embodiments, soot sheet 20 may have a starting density of between 0.2 g/cc to 0.8 g/cc, and through interaction with laser beam 26, soot sheet 20 densities into fully sintered glass silica sheet that has a density greater than 1.8 g/cc and less than 2.203 g/cc, and more specifically between 1.8 g/cc and less than 2.15 g/cc. In various embodiments, formation of bubbles, voids or surface depressions 50 may be controlled via control of laser operation and may also be formed from impact with particulate matter traveling from soot burner 16. In various embodiments, voids within silica glass sheet 28 and specifically depressions 50 may be advantageous in applications such as a substrate for carbon nanotube (CNT) growth where depressions 50 act to hold CNT catalyst.

For comparison, FIG. 9 shows a Zygo plot of a polished silica boule 60 formed from a non-laser sintering process, specifically a sliced and polished section from a silica ingot. As shown in FIG. 9, the polished silica boule 60 has a surface topology with a different appearance than the surface topologies of the different embodiments of sintered glass sheet 28 shown in FIGS. 5 and 6. For example, boule 60 has linear abrasion marks 62 that may be formed during different steps of the boule formation process, during handling and/or during polishing. In addition, the surface topology of boule 60 shown in FIG. 9 has directionality in which surface features extend generally in the direction of movement of the polishing device (extending from the upper left corner toward the bottom right corner in the image shown).

In contrast, the surface topology of the embodiments of silica glass sheet 28 shown in FIGS. 5 and 6 exhibit a more random distribution of peaks and valleys with little or no directionality. In such embodiments, silica glass sheet 28 does not include substantially elongated raised or recessed features, and in such embodiments, the maximum length and maximum width of raised and/or recessed features is less than 10 μm, specifically less than 3 μm and in some embodiments, less than 1 μm, within at least one 0.023 mm² area. In such embodiments, the raised and/or recessed features that are present on the surfaces of silica glass sheet 28 are substantially more random than those found in materials that have been polished or that have engineered surfaces (such as engineered porous surfaces). In some such embodiments, the raised and recessed features define a pitch, which is the distance between adjacent raised or recessed features (e.g., the distance along an axis between adjacent maxima of raised features or between adjacent minima of recessed features). In some embodiments, randomness of the surface features can be understood in terms of the pitch variability, which is a measurement of the deviation of each pitch from the average pitch along a surface of glass sheet 28. In addition, average pitch variability is the average of all of the pitch variations measured on a surface or on a surface subsection. In one embodiment, average pitch variability is at least 10% of the average pitch between the raised or recessed features, specifically is at least 25% of the average pitch between the raised or recessed features, and more specifically is at least 50% of the average pitch between the raised or recessed features. In various embodiments, Applicant believes that the random and/or relatively small surface features present in at least some versions of silica glass sheet 28, as discussed herein, may provide higher strength properties as compared to polished silica parts which may have surface defects or non-random surface features formed during polishing.

In some embodiments, silica glass sheet 28 may have bulk curvature or warp such that the opposing major surfaces of silica glass sheet 28 deviate somewhat from a planar configuration. As shown in FIGS. 8A-8C in some embodiments, one of the major surfaces of silica glass sheet 28 has concave shape extending across the width of sheet 28 such that the center of one of the major surfaces of sheet 28 is positioned lower than the lateral edges of sheet 28. In various embodiments, the warp of sheet 28 is between 0.5 mm and 8 mm as measured within an area of 3750 mm². In an example, the warp of a sample of sheet 28 was measured and taken from the Werth gauge on sheet 28 having dimensions 50 mm×75 mm. In another embodiment, the warp of sheet 28 is less than 20 μm across a 150 mm×150 mm square area. Alternatively, as discussed in more detail below, in various embodiments sheet 28 may be sintered in a manner to reduce warp and/or may be flattened following sintering to reduce warp.

In various embodiments, silica glass sheet 28 has two major surfaces, the upper surface formed from the portion of soot sheet 20 facing soot burner 16, and the lower surface formed from the portion of soot sheet 20 which is in contact with drum 12. In various embodiments, either the upper surface or the lower surface or both of silica glass sheet 28 may have any of the characteristics discussed herein. In specific embodiments, upper surface of silica glass sheet 28 may have the surface characteristics discussed herein, and the lower surface has surface configuration, topology, roughness, surface chemistry, etc. that is different from the upper surface resulting from the contact with drum 12. In a specific embodiment, the lower surface of silica sheet has a roughness (Ra) that is greater than that of the upper surface, and the Ra of the lower surface of silica glass sheet 28 may be between 0 and 1 μm. In another embodiment, lower surface of silica sheet 28 has a roughness (Ra) that is less than that of the upper surface, and in such embodiments, cleaning of the soot deposition surface (e.g., surface 14 of drum 12) following removal of the soot sheet may result in the high level of smoothness of the lower surface of silica sheet 28.

In various embodiments, laser 24 may be controlled in various ways to form a fully sintered or partially sintered glass sheet 28 having different characteristics, layers and/or surface structures. Starting with a porous body such as soot sheet 20, it is possible to obtain a different porosity and/or surface topology in a partially or fully sintered sheet by varying the sintering conditions. In one embodiment, a CO₂ laser heat source creates a narrow sintering region that can be leveraged to control the porosity and surface topology. In various embodiments, sintering speed, laser type and laser power combinations can be varied based on various characteristics of soot sheet 20 (e.g., material type, thickness, density, etc.), based on requirements of the product utilizing the sintered sheet 28, and/or based on the requirements of downstream processes. In various embodiments, system 10 discussed above can be operated to form sintered sheet 28 with various characteristics. In various embodiments, system 10 can be operated at a sintering speed (e.g., speed of relative movement between the soot sheet and the laser beam) between 0.5 mm/s and 5 mm/s, and laser 24 may be a CO₂ laser having a power between 100 W and 300 W. In some embodiments, soot sheet 20 passes through the laser sintering region of laser 24 a single time, and in other embodiments, soot sheet 20 passes through the laser sintering region of laser 24 multiple times.

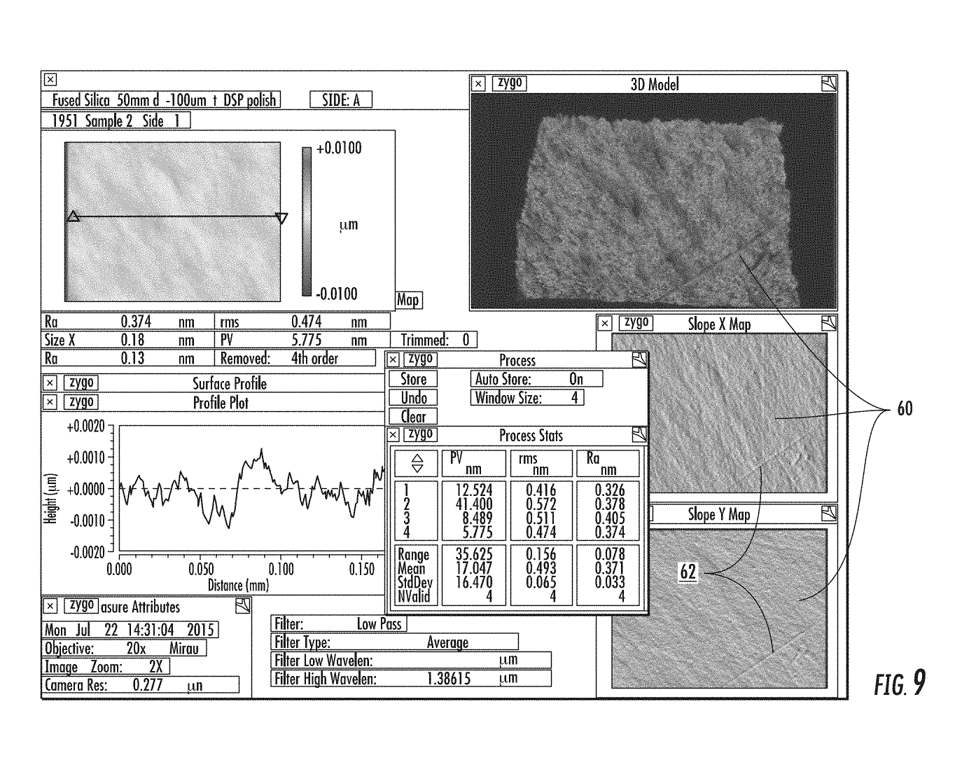

FIG. 10 provides examples of different structures that can be formed under different sintering conditions. As shown in the top pane of FIG. 10, a partially sintered glass sheet having a speckled surface structure can be formed by sintering a 500 micron soot sheet 20, having a bulk density of 0.35 g/cc, using 100 W CO₂ laser 24 generating an elongate laser beam (such as beam 42 in FIG. 2) with sintering speed (e.g., speed of relative movement between the soot sheet and the laser) of 0.65 mm/s. As shown in the middle pane of FIG. 10, a partially sintered glass sheet having more organized and linear surface structure can be formed by sintering a 500 micron soot sheet 20, having a bulk density of 0.35 g/cc, using 200 W CO₂ scanning laser 24 (e.g., as discussed above regarding FIG. 1) with a sintering speed (e.g., speed of relative movement between the soot sheet and the laser) of 1.3 mm/s. As shown in the bottom pane of FIG. 10, a fully sintered glass sheet having a smooth surface (as discussed herein) can be formed by sintering a 500 micron thick embodiment of soot sheet 20, having a bulk density of 0.35 g/cc, using 300 W CO₂ scanning laser 24 with sintering speed (e.g., speed of relative movement between the soot sheet and the laser) of 1.95 mm/s.

Further, in various embodiments, laser 24 may be controlled in various ways to form a fully sintered or partially sintered glass sheet 28 in which only a portion of soot sheet 20 is sintered such that a layer of sintered silica is supported by a lower layer of unsintered soot. In various embodiments, the remaining layer of soot may be removed prior to use of the sintered layer of silica, and in other embodiments, the remaining layer of soot may remain with the sintered layer of silica. In various embodiments, laser 24 may be controlled in various ways to form fully sintered structures within portions of unsintered soot. In some embodiments, sintered columns and/or hollow sintered tubes may be formed in soot sheet 20.

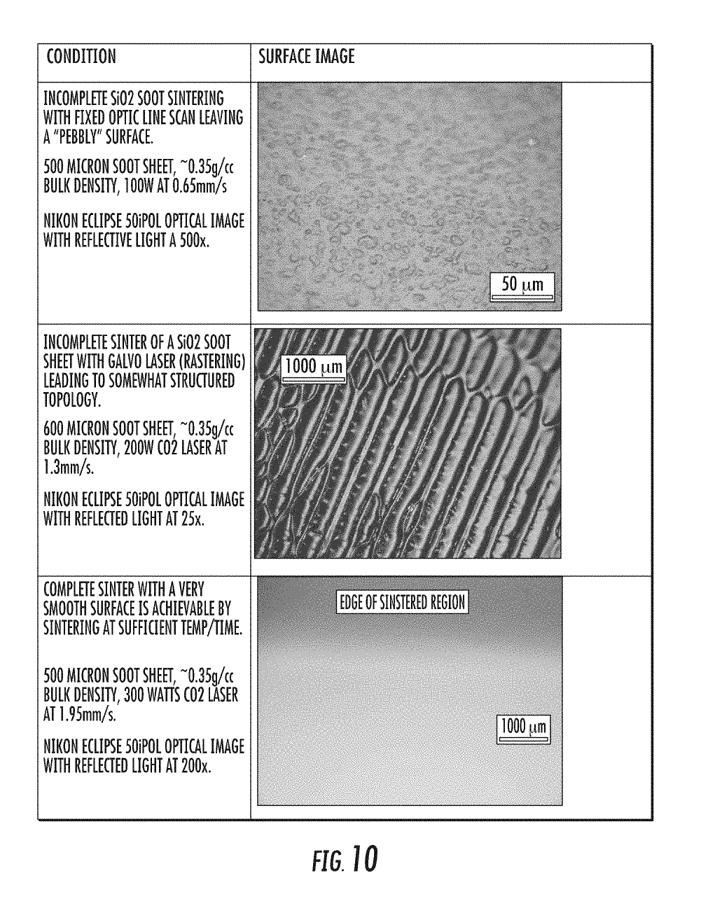

Referring to FIG. 1 and FIG. 11, system 10 includes a cutting laser 30 that generates a cutting laser beam 32 that cuts a subsection 34 of sintered glass from glass sheet 28. In addition to cutting subsection 34 from glass sheet 28, cutting laser 30 is configured to form an edge structure surrounding and defining the outer perimeter of cut subsection 34. In various embodiments, the edge structure is a thickened or bulblike section of melted silica material that may act to strengthen the cut subsection 34.

In various embodiments, cutting laser 30 is a focused CO₂ laser beam. In one exemplary embodiment, a CO₂ laser beam with a focal length of about 860 mm is focused down to 500 μm in diameter. At a laser power of 200 W, the average power density at the focus is 1020 W/mm². At this power density, laser ablation occurs, and a 100 μm thick silica sheet was cut at a speed of 70 mm/s. The peak energy density during the laser ablation process is 11 J/mm². In contrast to prior laser cutting contemplated by Applicant, it was found that this high powered, energy dense laser created the strengthening edge profile discussed below.

Referring to FIG. 11, a cross-sectional view of sintered silica glass subsection 34 showing curved or bulb-shaped edge section 70. As shown in FIG. 11, edge section 70 is a thickened section located adjacent the curved outwardly facing surface 72 that defines the outer perimeter of sintered glass subsection 34. In various embodiments, T1 is the average thickness of cut subsection 34 and may be within any of the thickness ranges of sheet 28 discussed herein, and edge section 70 has a maximum thickness T2. In various embodiments, T2 is greater than 10% larger than T1, specifically is greater 20% larger than T1, and more specifically is about 40% larger than T1. In specific embodiments, T1 is about 100 μm and T2 is about 140 μm. In various embodiments, the increased thickness at T2 is located close to the outermost point of outwardly facing surface 72, such as within 300 μm, specifically within 200 μm and more specifically within 100 μm of the outermost point of outwardly facing surface 72.

In various embodiments, bulb-shaped edge section 70 extends around substantially the entire perimeter of glass subsection 34 such that T2 represents the average maximum thickness through bulb section 70 around the perimeter of glass subsection 34. In other embodiments, bulb-shaped edge section 70 extends around the entire perimeter of glass subsection 34 such that T2 represents the maximum thickness at all cross-sectional positions around the perimeter of glass subsection 34. In general, shape of bulb-shaped edge section 70 and T2 can be adjusted using suitable laser focus diameter and laser power level.

Cut glass subsection 34 includes a first curved transition section 74 providing the transition from the first major surface 78 to the edge section 70, and a second curved transition section 76 providing the transition from the second major surface 80 to the edge section 70. As shown, curved transition section 74 has a radius of curvature that is less than the radius of curvature of curved transition section 76. In various embodiments, curved transition section 74 has a radius of curvature that is between 25 μm and 200 μm, and the radius of curvature of curved transition section 76 is between 100 μm and 500 μm.

In such embodiments, edge section 70 is formed via the cutting process and does not need a secondary formation step to form edge section 70. Further it has been found that the melting process to form edge section 70 via cutting laser has less flaws and has a higher edge strength as compared to an edge structure formed via grinding. In various embodiments, the edge strength of edge section 70 is greater than 100 MPa, specifically is greater than 150 MPa, and more specifically about 200 MPa (e.g., 200 MPa plus or minus 1%). In various high strength embodiments, the edge strength of edge section 70 is greater than 200 MPa, specifically is greater than 300 MPa, and more specifically about 350 MPa (e.g., 350 MPa plus or minus 1%). In various embodiments, edge section 70 acts to provide a high level of flexural strength, such as greater than 70 MPa, specifically greater than 100 MPa, and more specifically greater than 200 MPa. In various embodiments, the flexural strength of glass subsection 34 with edge section 70 is measured using a 2-point bend test. Such test methods determine the modulus of rupture (MOR) when bending glass and glass ceramics. Samples are subjected to mechanical flexure until failure occurs and peak load is recorded and converted to MOR. In such tests, MOR is the measure of flexural strength.

In various embodiments, the edge strength of edge section 70 can be further controlled, altered and/or enhanced by pre-heating the area that will form edge section such as through the use of a heater or a CO₂ laser beam prior to cutting. Preheating or annealing of the sheet prior to cutting reduces the amount of residual stress that may result from the cutting process. In an exemplary approach, a second laser beam may precede, coincide, or lag behind cutting laser beam 32. Preheating reduces the temperature difference of the cut region relative to the rest of the sheet, and thereby results in reduction in the residual stress that may result from the cutting process. Thus in this arrangement, annealing during the pre-heating step reduces the amount of residual stress from the cutting process, thus increasing edge strength.

In various embodiments, edge sections 70 of different sizes, thickness, shapes, etc. may be formed by increasing or decreasing laser power and/or movement speed. In some embodiments, tension in the length and/or width direction may be applied to sheet 28 during cutting by cutting laser 30 to influence the shape of edge section 70.

In yet further embodiments, system 10 is configured to produce sintered silica glass sheets, such as sheet 28, or cut glass subsections, such as subsection 34, having a very low degree of warp (e.g., a high degree of flatness). In various embodiments, the highly flat, sintered glass sheets discussed herein also include any combination of the silica sheet features (e.g., roughness, purity, chemical compositions, surface characteristics, strengthening edge shape, fictive temperature characteristics, etc.) discussed herein. As discussed in detail herein, highly flattened silica sheets may be produced via a post-sintering flattening process, alone or in combination, with control of various sintering process parameters that increase or result in sheet flatness. In various embodiments, high levels of flatness may provide various advantages in various applications, such as increasing uniformity in the deposition, growth, alignment, fixturing, machining and or stacking of multiple silica sheets 28. In particular, improved flatness may increase repeatable alignment of parts incorporating sheets 28, in various assembly operations.

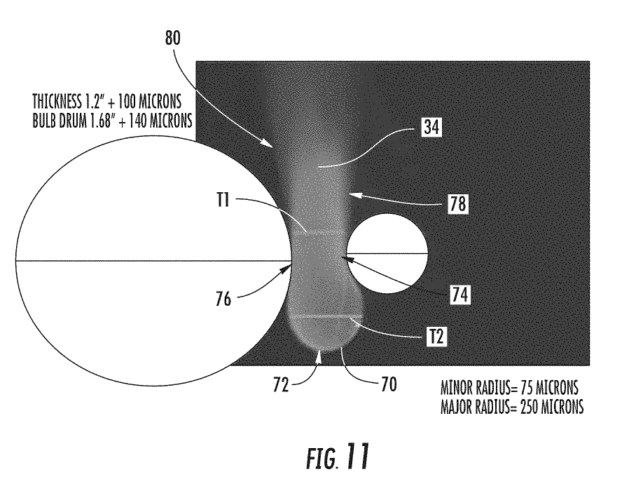

Referring to FIGS. 12-17, a system and method for post-sinter flattening of a sintered glass sheet, such as sheet 28, or of cut glass subsections, such as subsection 34, is shown and described. Referring to FIGS. 12-14, flattening system 100 is shown, according to one embodiment. Flattening system includes a lower plate or support, shown as setter plate 102, a top plate 104, and a heating system, shown as induction heater 106. In general, sintered silica glass sheet 28 is placed on setter plate 102. As can be seen in FIG. 12, glass sheet 28 has a relatively high degree of warp, and in particular, glass sheet 28 has an arched shape in which the central region 108 is spaced a distance above (in the orientation of FIG. 12) of the outer perimeter 110 of glass sheet 28. Thus, prior to heating, outer perimeter 110 of glass sheet 28 is in contact with upper surface 112 of setter plate 102, and central region 108 of glass sheet 28 is spaced from upper surface 112 of setter plate 102.

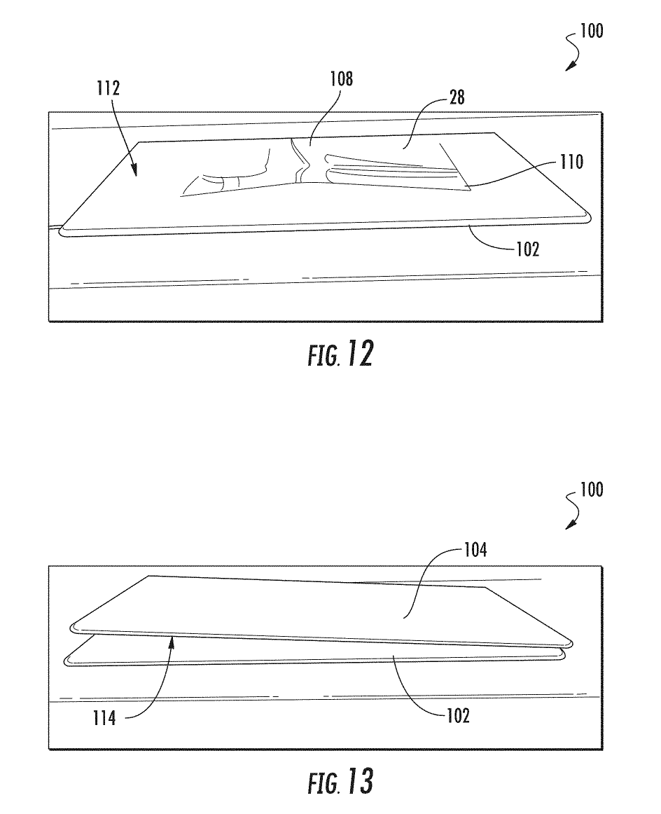

As shown in FIG. 13, after glass sheet 28 is placed onto setter plate 102, top plate 104 is placed on top of sheet 28 such that lower surface 114 of top plate 104 is in contact with the upper surface of glass sheet 28. The angle of top plate 104 in FIG. 13 results from the warped shape of glass sheet 28.

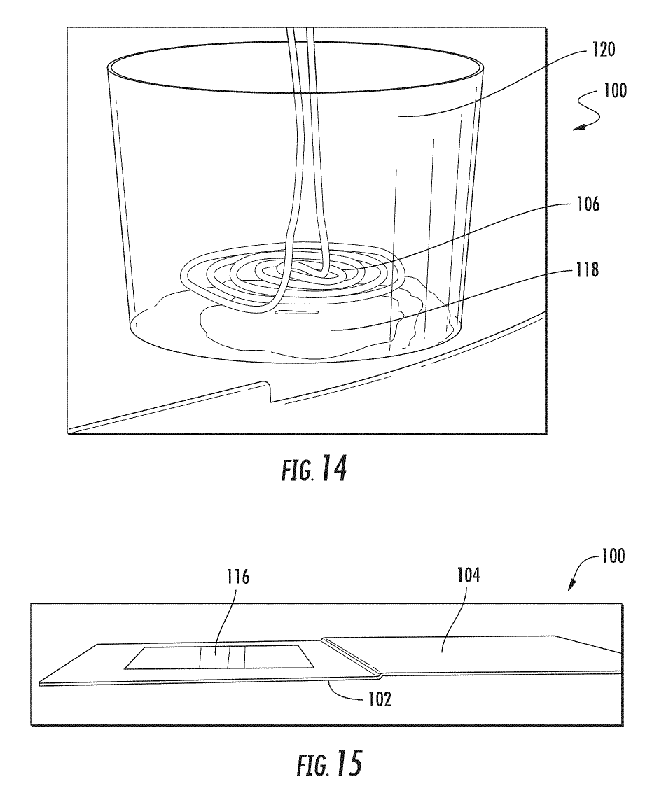

As shown in FIG. 14, with glass sheet 28 between plates 102 and 104, induction heater 106 heats glass sheet 28. As glass sheet 28 is heated, the weight of top plate 104 acts as a force acting downward on glass sheet 28. Through the application of heat by induction heater 106 and of the force applied by top plate 104, glass sheet 28 is flattened forming flattened glass sheet 116 as shown in FIG. 15. In particular embodiments, glass sheet 28 is heated to above its glass transition temperature such that it may be flattened under the weight of plate 104. In specific embodiments, system 100 reduces the degree of warp present in sheet 28 to produce flattened sheet 116 while maintaining the various other properties of sheet 28 discussed herein, such as surface roughness, surface features, purity, etc. In the exemplary embodiment show, glass sheet 28 is a 50 mm by 50 mm sintered glass sheet, and plates 102 and 104 have a thickness of 1 mm.

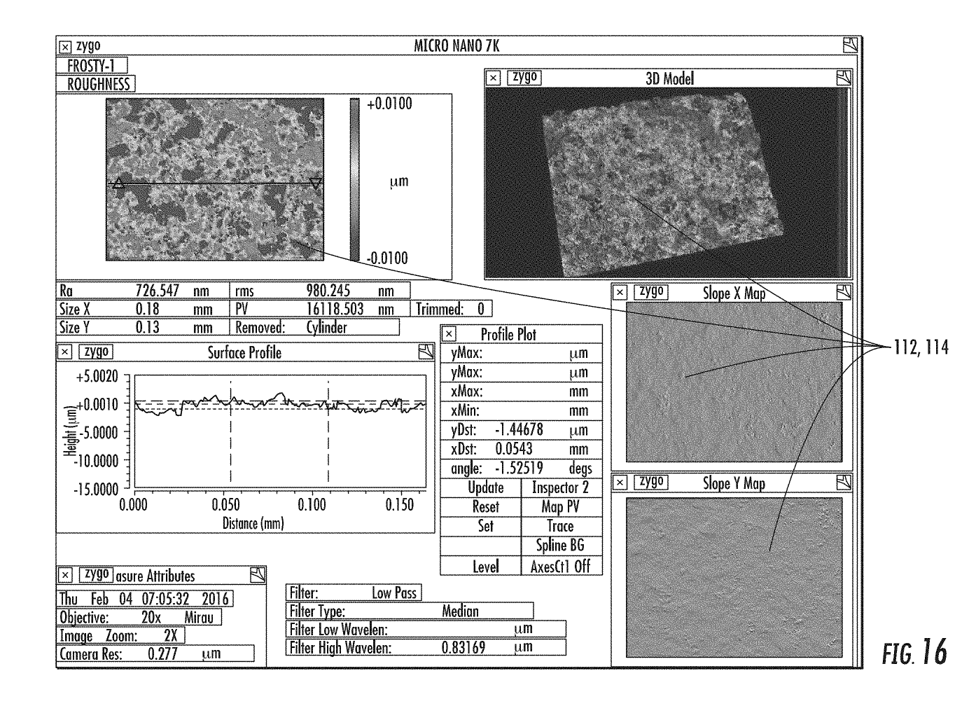

In various embodiments, plates 102 and 104 are formed from a silica material, and in particular are formed from a highly pure silica material, such as high purity fused silica. By contacting sheet 28 with high purity silica plates during flattening, the high silica purity of glass sheet 28 can be maintained by preventing glass sheet 28 from absorbing contaminants from plates 102 and 104. However, Applicant discovered that glass sheet 28 and silica plates 102 and 104 tend to bond together during heating if the temperature is too high or if surfaces 112 and 114 of plates 102 and 104, respectively, are too smooth. Accordingly, Applicant identified that silica plates 102 and 104 having surfaces 112 and 114 each having surface roughness (Ra) greater than 500 nm, specifically greater than 600 nm and more specifically greater than 700 nm allows glass sheet 28 to easily release from plates 102 and 104 following flattening. FIG. 16 is Zygo plot of surface 112 and 114 showing an Ra roughness of 726.547 nm, and Applicant's found that plates 102 and 104 having the surface roughness shown in FIG. 16 did not bond to glass sheet 28 during flattening.

Referring back to FIG. 14, Applicant has also identified that induction heater 106 may be controlled to facilitate release of plates 102 and 104 from glass sheet 28 following flattening. In particular, without being bound by a particular theory, Applicant believes that if system 100 is heated too high for too long, the roughness of surfaces 112 and 114 will decrease which in turn increases the degree of bonding between plates 102 and 104 and glass sheet 28. In various embodiments, Applicant has found that in order to maintain the roughness of surfaces 112 and 114, induction heater 106 is controlled to maintain the maximum temperature of plates 102 and 104 below 1800 degrees C., and specifically between 1300 and 1800 degrees C. As will be understood, because the degree to which surfaces 112 and 114 lose their roughness during heating varies based on the amount of time spent at a particular temperature, the maximum allowable temperature is inversely related to the amount of time plates 102 and 104 are exposed to heating during the flattening operation.

It should be understood that while FIG. 14 shows an induction based heating system as part of flattening system 100, system 100 may include any of a variety of heating systems that can reach glass transition temperatures. However it is believed that induction based heating systems are particularly suitable options allowing for fast cycle time and flexibility in part shape and size.

As shown in FIG. 14, in various embodiments, flattening system 100 may be further configured to provide desirable heat distribution and/or to maintain high silica purity of glass sheet 28. For example, as shown in FIG. 14, system 100 includes a susceptor, shown as graphite susceptor 118, located below setter plate 102. As will be generally understood, graphite susceptor 118 is a block of resistive material capable of absorbing electromagnetic energy from induction heater 106 which in turn heats susceptor 118, and the heat from susceptor 118 is conducted to glass sheet 28. In other embodiments, the susceptor may be formed from a metal material, and in other embodiments, continuous process furnaces designed for high throughput part flattening may be used.

Further, system 100 may include an enclosure, shown as enclosure 120, for controlling the atmosphere that glass sheet 28 is exposed to during heating and flattening. By controlling the atmosphere during heating, the purity of glass sheet 28 can be maintained or controlled by controlling the degree to which impurities are imparted to glass sheet 28 during flattening. In various embodiments, enclosure 120 may be filled with an inert or non-reactive atmosphere (a nitrogen atmosphere, noble gas atmosphere, etc.) during flattening. In other embodiments, a vacuum may be drawn within enclosure 120 during flattening. In particular embodiments, removing the atmospheric air and/or providing inert gas around the graphite susceptor acts to remove O₂ and/or moisture from system 100 during flattening. It is believed that O₂ may allow the graphite susceptor to burn, and H₂O may cause plates 102 and 104 to stick more easily to glass sheet 28 during flattening. Thus, operation of system 100 may be improved by the removal of O₂ and/or H₂O from the atmosphere within enclosure 120.

It should be understood that while the specific embodiment of flattening system 100 shown utilizes a top plate 104 to provide the flattening force onto glass sheet 28, the flattening force may be applied to glass sheet 28 in other ways. For example, in one embodiment, the flattening force applied to glass sheet 28 is the gravitational force acting on sheet 28, and in such an embodiment, glass sheet 28 is flattened under its own weight. In other embodiments, gas pressure or gas jets are directed onto glass sheet 28 pressing the glass sheet onto setter plate 102. In yet another embodiment, a vacuum may be applied to the lower surface of glass sheet 28 pulling glass sheet 28 downward, and in a specific embodiment, setter plate 102 includes a plurality of apertures allowing the pulling vacuum to be evenly distributed across a portion or across all of surface 112.

In yet other embodiments, the flattening process may be utilized to further alter glass sheet 28. In a particular embodiment, surfaces 112 and/or 114 may include a shape, pattern, etc., which is imprinted or embossed onto the lower and/or upper surfaces of glass sheet 28 during flattening.

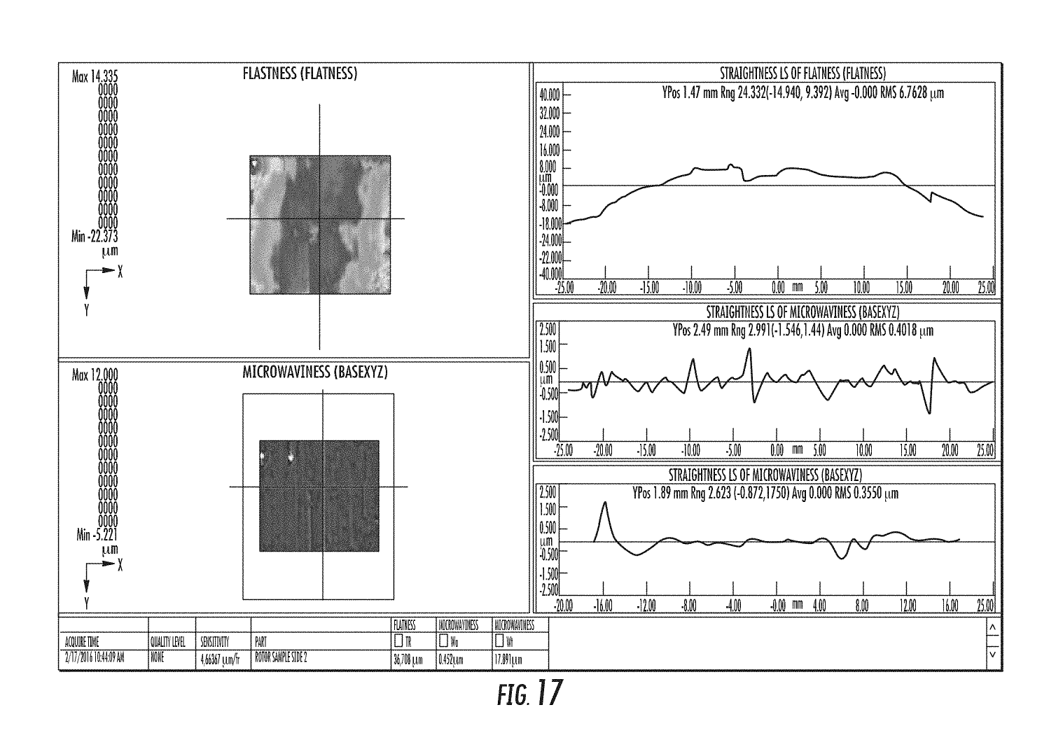

Referring to FIG. 17 and FIG. 18, the high level of flatness or low level of warp present in flattened glass sheet 116 is shown and described. In general, as used herein, warp refers to the shape of glass sheet 116 at a macroscopic or sheet-wide scale. FIG. 18 provides an illustration of how warp is determined, measured or calculated, according to an exemplary embodiment. As shown in FIG. 18, line C is the least squares focal plane defined along an article (e.g., sheet 116, sheet 28, glass subsection 34, etc.) at a cross-sectional position through the article. In at least some embodiments, when warp is determined using the definition shown in FIG. 18, the sheet is in a free or unweighted/unclamped state. As shown, point B is the lowest point of the sheet, and point A is the highest point of the sheet. In this definition of warp/flatness, warp is the maximum distance between the highest point (A) and lowest point (B) from the least squares focal plane (C). In this embodiment, warp measurements are positive, and warp is determined by measuring the displacement from the least squares focal plane across the entire sheet or across an entire defined subsection (rather than simply measuring at a particular set of points, such as at the center point).

In various embodiments, warp of flattened glass sheet 116 is less than 1 mm, less than 500 μm, less than 50 μm, or less than 10 μm. In particular embodiments, these warp measurements are maximum warp as measured over an entire area of sheet 116 utilizing the definition shown in FIG. 18. In particular embodiments, these warp measurement are the maximum warp as measured over at least one section of the glass sheet having an area of 50 mm by 50 mm or alternatively having an area greater than 2500 mm² utilizing the definition shown in FIG. 18. As noted above, sheet 28 may have levels of warp greater than 1 mm, and thus, flattening system 100 is able to achieve high levels of flattening relative to the initial levels of warp. In various embodiments, warp of flattened glass sheet 116 is less than 50% of the warp of sheet 28, less than 10% of the warp of sheet 28, and even less than 1% of the warp of sheet 28. In some such embodiments, the surface roughness Ra of the major surfaces of sheet 28 and sheet 116 remains with the same range both before and after flattening. In some such embodiments, the purity of sheet 28 and sheet 116 remains within the same range both before and after flattening.

In various embodiments, flattened glass sheet 116 includes the low levels of warp discussed herein in combination with any of the other glass sheet properties discussed herein. In a particular embodiment, flattened glass sheet 116 includes the low warp measurements discussed herein and one or both of the major surfaces of flattened glass sheet 116 has a total indicator run-out (TIR) measurement of less than 50 μm, a microwaviness measurement (Wa) of less than 0.5 μm, and/or a microwaviness measurement (Wt) of less than 20 μm. Referring to FIG. 17, measurements of warp and microwaviness of flattened sheet 116 are shown according to exemplary embodiments. In one exemplary embodiment, glass sheet 28 has an area of 50 mm by 50 mm, warp of between 1 and 1 mm, and TIR of more than 10 mm. As shown in FIG. 17, following flattening using the process described above, TIR was reduced to below 50 μm (specifically 36.7 μm).

In various embodiments, instead of or in addition to utilizing post-sintering flattening system 100, various aspects of system 10 may be controlled to increase flatness of sintered glass sheet 28 produced by system 10. In some such embodiments, glass sheet 28 may have any of the low warp characteristics of sheet 116 discussed above without the need to be processed through flattening system 100.

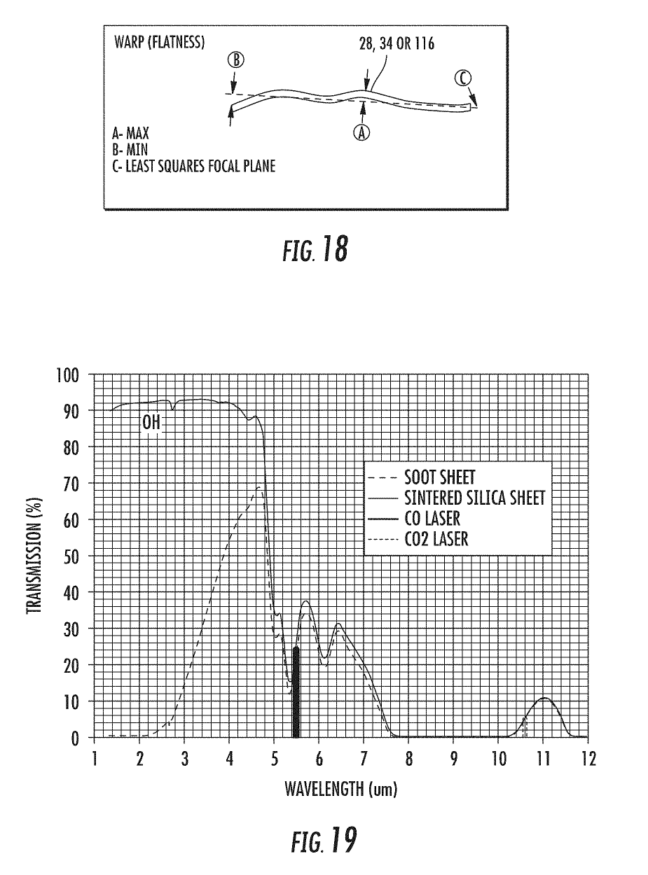

In various embodiments, as represented by the graph in FIG. 19, one or more properties of sintered glass sheet 28 may be selected, controlled or altered based on the wavelength of sintering laser 24. As shown in FIG. 19, infrared laser absorption of silica soot and the sintered silica sheet varies based on the wavelength of sintering laser 24. As one example, soot sheet 20 has a thickness of about 450 μm, and sintered silica sheet 28 has a thickness of 100 μm. As shown in FIG. 19, at the CO laser wavelength of 5.5 μm, the amount of transmission of the soot and the silica sheets is roughly 25%, and at the 10.6 μm CO₂ laser wavelength, the amount of transmission is 5%.

It is believed that the higher transmission of the 5.5 μm wavelength energy of the CO laser heats soot sheet 20 more uniformly than a CO₂ laser does. It is believed that the significant attenuation through soot sheet 20 at the 10.6 μm CO₂ laser wavelength results in a significant temperature gradient through the soot and glass thickness. This temperature gradient is reduced as thermal homogenization takes place.

In various embodiments, laser sintering as discussed herein provides sintered silica glass sheet 28 with a low fictive temperature. For example, in various embodiments, the fictive temperature of glass sheet 28 may be less than 1400 degrees C., specifically less than 1300 degrees C., more specifically greater than 1100 degrees C. and less than 1300 degrees C. and more even more specifically greater than 1200 degrees C. and less than 1300 degrees C. It is believed that a low fictive temperature sintered silica glass sheet, such as glass sheet 28, may have superior strength and lower residual stress as compared to a silica material having a higher fictive temperature. By way of comparison, Applicant understands that at least some prior silica materials had fictive temperatures in the range of 1771-1790 degrees C.

In particular embodiments, Applicant has found that glass sheet 28 has a fictive temperature of between 1240 and 1260 degrees C., and more specifically of 1252 degrees C. when sintered utilizing a CO₂ laser. In other embodiments, Applicant has found that glass sheet 28 has a fictive temperature of between 1225 and 1245 degrees C., and more specifically of 1235 degrees C. when sintered utilizing a CO₂ galvo-laser. In other embodiments, Applicant has found that glass sheet 28 has a fictive temperature of between 1215 and 1235 degrees C., and more specifically of 1228 degrees C. when sintered utilizing a CO galvo-laser. Applicant believes that laser sintering, such as sintering with either a CO laser or a CO₂ laser as discussed herein, forms a sintered glass sheet 28 having a fictive temperature that is less than the fictive temperature of silica sintered by other methods, such as flame sintering, induction sintering, etc.

In additional embodiments, flatness of the sintered glass sheet 28 can be improved by controlling the shape and or position of the soot sheet 20 during sintering. By way of explanation, silica and high silica soot sheet 20 have low thermal expansion. In the case of silica, the thermal expansion coefficient is ˜0.55×10⁻⁶/° C. During sintering, temperature in excess of 2000° C. is deduced from the observation of onset of silica vaporization at the laser-soot interaction surface. After sintering, the thin silica sheet rapidly cools down to room temperature due to its low thermal retention capability. The amount of shrinkage for a 150 mm silica sheet is ˜0.17 mm which occurs in a short amount of time. If a shape (other than flat sheet) is present in the silica sheet, a sudden geometrical shape change can occur during cooling and this may affect the sintering process, may reduce flatness, may create a line defect, etc.

In exemplary embodiments, system 10 is configured to maintain or improve flatness of soot sheet 20 using an active tensioning device on the soot sheet 20 adjacent to the laser sintering front. Such a device acts to put soot sheet 20 in tension and keep soot sheet 20 flat locally. The sintered glass sheet 28 will retain the flatness and form a sheet having low warp. As the flat sintered sheet 28 is cooled to room temperature it will not substantially change its shape and affect the sintering process.

As another example, flatness of sintered glass sheet 28 can be improved by orienting soot sheet 20 vertically during sintering. It is believed that when soot sheet 20 is positioned horizontally or at an angle relative to vertical during the laser sintering process, sagging due to gravity of the locally formed silica agglomerates will occur if the viscosity is low enough. The variations in the viscosity will cause the sheet to develop a non-planar shape. It is believed that by sintering soot sheet 20 in the vertical position, shape changes from low viscosity are reduced or minimized.

In exemplary embodiments, system 10 is configured to maintain or improve flatness of sintered glass sheet 28 by controlling the temperature drop of sintered silica sheet 28 following sintering. In particular embodiments, system 10 is configured to heat sintered sheet 28 and/or soot sheet 20 with one or more broad area heaters, with a defined temperature drop along the processing direction. Heating from the heater(s) will decrease the thermal gradient along the sintering axis, such that even if a shape change occurs from the cooling process, it is located far enough away from the sintering region that it will not affect the sintering process and does not introduce line defects.

As yet another exemplary embodiment, flatness of sintered glass sheet 28 may be improved by providing a more even soot density and/or soot thickness distribution from soot deposition burner 16. Applicant believes that soot density/thickness variations cause variations in the sintering parameters and hence a sheet shape develops during and after sintering process stemming from the soot density/thickness variations. By providing a soot deposition burner which generates a low degree of density and/or of thickness variation within soot sheet 20, flatness of sintered sheet 28 may be increased.

In exemplary embodiments, system 10 is configured to maintain or improve flatness of sintered glass sheet 28 by controlling one or more characteristic (e.g., shape, size, speed, uniformity, etc.) of laser beam 26 during sintering. In one embodiment, flatness of sintered silica sheet 28 is increased by increasing the uniformity of laser beam 26 as it is scanned across soot sheet 20. In various embodiments, uniformity of laser beam 26 can be increased in a number of ways, such as by using a laser with active power control, a scanner with telecentric lens (f-theta lens), and/or by increasing sintering speed. A scanner (such as a spinning polygon, an electro-optical scanner, an acousto-optical scanner) with high scan rate, in combination with a high power CO₂ or CO laser can be used to improve the sintering efficiency and increase the sintering speed. Increasing sintering speed will indirectly result in decreased temperature gradient along the sintering axis, which in turn may improve flatness of sintered sheet 28.

In another embodiment, flatness of sintered silica sheet 28 may be increased by slowing down the scanning rate of laser beam 26 in a galvo sintering approach such that soot sheet 20 is sintered in one pass. In a CO₂ laser sintering process, the sintering time is predominantly determined by the thermal diffusion time through the thickness. The sintering speed of the one-pass approach can thus be approximated by the beam diameter divided by thermal homogenization time through the soot thickness, and thus, operating sintering laser 24 such that this sintering speed achieved is believed to increase flatness of sintered silica sheet 28.

In another embodiment, flatness of sintered silica sheet 28 may be increased by using a sintering laser 24 that generates a sintering laser beam 26 with an intensity distribution (top-hat, trapezoidal, donut, etc.) that reduces or minimizes fictive temperature variations generated during the sintering process. Many lasers output a laser beam with a Gaussian intensity distribution. During sintering, a Gaussian distribution tends to generate a hotter spot in the middle of the beam with a rapidly falling temperature distribution moving away from the hot spot. In various embodiments, laser 24 is configured to generate a laser beam 26 with an intensity distribution that minimizes temperature variations across the laser spot and reduces fictive temperature variations in the silica sheet. Other benefits of using such a beam profile can include increased sintering efficiency and speed.

In some embodiments, sintered silica glass sheet 28 consists of at least 99.9% by weight, and specifically at least 99.99% by weight, of a material of the composition of (SiO₂)_{1-x-y}.M′ₓM″_{y}, where either or both of M′ and M″ is an element (e.g., a metal) dopant, or substitution, which may be in an oxide form, or combination thereof, or is omitted, and where the sum of x plus y is less than 1, such as less than 0.5, or where x and y are 0.4 or less, such as 0.1 or less, such as 0.05 or less, such as 0.025 or less, and in some such embodiments greater than 1×10⁻⁶ for either or both of M′ and M″. In certain embodiments, sintered silica glass sheet 28 is crystalline, and in some embodiments, sintered silica glass sheet 28 is amorphous.

In various embodiments, sintered silica glass sheet 28 is a strong and flexible substrate which may allow a device made with sheet 28 to be flexible. In various embodiments, sintered silica glass sheet 28 is bendable such that the thin sheet bends to a radius of curvature of at least 500 mm without fracture when at room temperature of 25° C. In specific embodiments, sintered silica glass sheet 28 is bendable such that the thin sheet bends to a radius of curvature of at least 300 mm without fracture when at room temperature of 25° C., and more specifically to a radius of curvature of at least 150 mm without fracture when at room temperature of 25° C. Bending of sintered silica glass sheet 28 may also help with roll-to-roll applications, such as processing across rollers in automated manufacturing equipment.

In various embodiments, sintered silica glass sheet 28 is a transparent or translucent sheet of silica glass. In one embodiment, sintered silica glass sheet 28 has a transmittance (e.g., transmittance in the visual spectrum, transmittance of light having a wavelength between 300 and 2000 nm) greater than 90% and more specifically greater 93%. In various embodiments, the sintered silica glass sheets discussed herein have a softening point temperature greater than 700° C. and more specifically greater than 1100° C. In various embodiments, the sintered silica glass sheets discussed herein have a low coefficient of thermal expansion less than 10×10-7/° C. in the temperature range of about 50 to 300° C.

While other sintering devices may be used to achieve some embodiments, Applicants have discovered advantages with laser sintering in the particular ways disclosed herein. For example, Applicants found that laser sintering may not radiate heat that damages surrounding equipment which may be concerns with sintering via induction heating and resistance heating. Applicants found that laser sintering has good control of temperature and repeatability of temperature and may not bow or otherwise warp sheet 28, which may be a concern with some other sintering methods. In comparison to such other processes, laser sintering may provide the required heat directly and only to the portion of the soot sheet needing to be sintered. Laser sintering may not send significant amounts of contaminates and gases to the sintering zone, which may upset manufacturing of the thin sheets. Further, laser sintering is also scalable in size or for speed increases.

In various embodiments, the silica soot sheets disclosed herein are formed by a system that utilizes one or more glass soot generating device (e.g., a flame hydrolysis burner) that is directed or aimed to deliver a stream of glass soot particles on to a soot deposition surface. As noted above, the silica sheets discussed herein may include one or more dopant. In the example of a flame hydrolysis burner, doping can take place in situ during the flame hydrolysis process by introducing dopant precursors into the flame. In a further example, such as in the case of a plasma-heated soot sprayer, soot particles sprayed from the sprayer can be pre-doped or, alternatively, the sprayed soot particles can be subjected to a dopant-containing plasma atmosphere such that the soot particles are doped in the plasma. In a still further example, dopants can be incorporated into a soot sheet prior to or during sintering of the soot sheet. Example dopants include elements from Groups IA, IB, IIA, IIB, IIIA, IIIB, IVA, IVB, VA, VB and the rare earth series of the Periodic Table of Elements. In various embodiments, the silica soot particles may be doped with a variety of materials, including germania, titania, alumina, phosphorous, rare earth elements, metals and fluorine.

### EXAMPLE 1

A 400 micron thick soot sheet, composed of essentially 100% silica, was prepared using the process as described in U.S. Pat. No. 7,677,058. A section of soot sheet 9 inches wide by 12 inches long was laid on a translating table in proximity to a CO₂ laser. The laser was a 400 W CO₂ laser, model number E-400, available from Coherent Inc. An asymmetric aspherical lens was positioned between the laser and the soot sheet. The asymmetric aspherical lens generates a line beam of 10 mm long and approximately 1 mm wide with uniform intensity distribution across both long and short axis. The lens was placed roughly 380 mm away from the soot sheet. A laser power of 18 watts of power was used. The soot sheet was moved at 1.25 mm/sec across the beam. Clear, sintered glass, fully densified, was created in the path of the beam. The sintered sheet had a surprisingly low amount of distortion as the soot was densified and shrunken away from the remaining soot sheet. In other sintering systems, the soot sheet would bend and deform unless held flat in a plane during the sinter process.

### EXAMPLE 2

Example 2 is the same as Example 1, except that the soot sheet was translated at 1.5 mm/sec. This produced a partially densified layer of glass atop of unsintered soot sheet.

### EXAMPLE 3

Example 3 is the same as Example 1, except that the essentially 100% silica soot sheet was solution doped to provide a small doping of Yb in the silica matrix, when sintered with the laser.

### EXAMPLE 4

In one exemplary test of flattening system 100, the heating system was an L80 Induction system by Ameritherm and was used to heat a 6 inch diameter graphite disk susceptor to 1300° C. 25 kW of power heated the graphite disk susceptor to a center temperature of 1300 C and an edge temperature of 1820 C. The sintered glass sheet (such as sheet 28) was 50 mm×50 mm×100 microns thick with a warp of about 10 mm, and the sintered glass sheet was placed on the 1 mm thick high purity fused silica setter plate, approximately 80 mm×80 mm. This setter plate had a roughened upper surface having a roughness (Ra) of about 726.5 nm as shown in FIG. 16. The setter plate was placed directly onto the graphite susceptor. The sintered glass sheet was covered with another 1 mm HPFS plate as shown in FIG. 13. In this example, two additional 1 mm thick pieces of HPFS were placed on top of the top plate to add additional weight of about 28 grams on to the sintered silica glass sheet. The power was applied at 25 kW and the cycle time was 160 seconds. Upon turn-off, the plates were disassembled with the help of rapid gas cooling. The now flattened sintered glass sheet was removed from the assembly, and significant decrease in warp was measured without significant increase in roughness or waviness on the surfaces of the flattened sintered glass sheet. As shown in FIG. 17, following flattening using the process described above, TIR was reduced to about 36.7 μm, microwaviness (Wa) was 0.462 μm and microwaviness (Wt) was 17.891 μm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

In some embodiments, laser 24 may be suited for sintering particularly thin soot sheets that are less 3000 μm. In various embodiments, system 10 is a high speed sintering system having a relative speed in the direction of arrow 22 between 1 m/s and 25 m/s. In contemplated embodiments, the heater 106 may be integrated in an oven, kiln, and/or lehr. In contemplated embodiments, surface roughness of plates 102 and 104 may be augmented and/or replaced by graphite sheets and/or carbon to facilitate non-sticking/non-bonding during flattening. In various embodiments, Applicant has found that in order to maintain the roughness of surfaces 112 and 114, induction heater 106 is controlled to maintain the maximum temperature of plates 102 and 104 below 1800 degrees C., and specifically between 1200 and 1800 degrees C. Further, Applicants discovered that releasing the sheet 28 is improved at temperatures above room temperature (25° C.), such as at temperatures of at least 300° C., at least 500° C., and/or no more than 800° C., such as no more than 600° C. In some embodiments, the sheet 28 is heated and pressed flat as disclosed herein for a time of less than 5 hours, such as less than 1 hour, such as less than 10 minutes.

What is claimed is:

1. A method for making a thin sintered silica sheet comprising:
forming a glass soot sheet by delivering a stream of glass soot particles from a soot generating device to a soot deposition surface;
directing a laser beam of a sintering laser onto the glass soot sheet;
moving at least one of the glass soot sheet and the laser beam relative to the other;
forming a sintered glass sheet from the glass soot sheet by delivering the laser beam from the sintering laser onto the glass soot sheet, wherein the sintered glass sheet has an average thickness and an as-sintered average warp, wherein the average thickness of the sintered glass sheet is less than 500 μm;
applying a force to the sintered glass sheet to form a flattened glass sheet, wherein the flattened glass sheet has an average warp that is less than the as-sintered average warp; and
wherein the sintered glass sheet is above a glass transition temperature of the sintered glass sheet while the force is applied.

2. The method of claim 1, wherein the as-sintered average warp is greater than 1 mm, and the average warp of the flattened glass sheet is less than 1 mm.

3. The method of claim 2, wherein the as-sintered average warp is greater than 1 mm, and the average warp of the flattened glass sheet is less than 50 μm.

4. The method of claim 1, wherein the average warp of the flattened glass sheet is less than 50% of the as-sintered average warp.

5. The method of claim 1, wherein the applying the force lasts for less than 1 hour.

6. The method of claim 5, wherein the sintered glass sheet is located between a lower plate and an upper plate during the applying, and the applied force includes weight of the upper plate.

7. The method of claim 6, wherein the lower plate has an upper surface and the upper plate has a lower surface, wherein the Ra roughness of both the upper surface and the lower surface is greater than 500 nm.

8. The method of claim 7, wherein the sintered glass sheet is heated to a temperature between 1100-1800 degrees C., wherein the Ra roughness of both the upper surface and the lower surface is greater than 700 nm.

9. The method of claim 5, wherein the applying occurs in an enclosure having at least one of an inert atmosphere and a vacuum within the enclosure.

10. The method of claim 1, wherein the sintering laser is CO laser.

11. The method of claim 1, wherein applying the force includes at least one of directing a stream of gas onto a surface of the sintered glass sheet and applying a vacuum to a surface of the sintered glass sheet.

12. The method of claim 1, wherein the sintered glass sheet has a first major surface and a second major surface, where the step of forming the glass soot sheet and the step of forming a sintered glass sheet are performed such that a roughness (Ra) of the first major surface of the sintered glass sheet is between 0.025 nm and 1 nm over at least one 0.023 mm² area of the first major surface, wherein the flattened glass sheet has a first major surface and a second major surface, where the step of applying the force to flatten the sintered glass sheet is performed such that a roughness (Ra) of the first major surface of the flattened glass sheet is between 0.025 nm and 1 nm over at least one 0.023 mm² area of the first major surface.

13. A high purity sintered silica glass sheet comprising:
a first major surface;
a second major surface opposite the first major surface;
at least 99.9 mole % silica;
an average thickness between the first major surface and the second major surface of less than 500 μm; and
an average warp of less 1 mm over at least one area of 2500 mm²;
wherein a roughness (Ra) of the first major surface is between 0.025 nm and 1 nm over at least one 0.023 mm² area of the first major surface.

14. The high purity sintered silica glass sheet of claim 13, wherein the average warp is less 50 μm over at least one area of 2500 mm².

15. The high purity sintered silica glass sheet of claim 13, wherein the average warp is less 10 μm over at least one area of 2500 mm².

16. The high purity sintered silica glass sheet of claim 13, further comprising a fictive temperature of less than 1400 degrees C.

17. The high purity sintered glass sheet of claim 16, wherein the fictive temperature is between 1200 degrees C. and 1300 degrees C.

18. The high purity sintered silica glass sheet of claim 13, wherein the roughness (Ra) of the first major surface of the sintered glass sheet is between 0.025 nm and 0.2 nm over at least one 0.023 mm² area of the first major surface.

19. The high purity sintered silica glass sheet of claim 13, wherein the first major surface includes a plurality of raised and recessed features each having a length and a width, wherein within at least one 0.023 mm² area of the first major surface, the maximum length and the maximum width of the raised features are less than 10 μm.

20. The high purity sintered silica glass sheet of claim 19, wherein the raised and recessed features are spaced from one another defining an average pitch along the first major surface and defining an average pitch variability, wherein the average pitch variability is at least 10% of the average pitch.

21. A high purity sintered silica glass sheet comprising:
a first major surface;
a second major surface opposite the first major surface;
at least 99.9 mole % silica;
an average thickness between the first major surface and the second major surface of less than 500 μm; and
a fictive temperature of less than 1400 degrees C.

22. The high purity sintered silica glass sheet of claim 21, wherein the fictive temperature is between 1200 degrees C. and 1300 degrees C.

23. The high purity sintered silica glass sheet of claim 21, further comprising an average warp of less 1 mm over the entire sheet.

24. The high purity sintered silica glass sheet of claim 21, the average warp of less 10 μm over the entire sheet, wherein the first and second major surfaces each have an area greater than 2500 mm².

25. The high purity sintered silica glass sheet of claim 21, wherein a roughness (Ra) of the first major surface of the sintered glass sheet is between 0.025 nm and 0.2 nm over the entire first major surface.

26. The high purity sintered silica glass sheet of claim 21, wherein the first major surface includes a plurality of raised and recessed features each having a length and a width, wherein the maximum length and the maximum width of the raised features are less than 10 μm.

27. The high purity sintered silica glass sheet of claim 26, wherein the raised and recessed features are spaced from one another such that an average pitch is defined along the first major surface and that an average pitch variability defined, wherein the average pitch variability is at least 10% of the average pitch.

28. A method for making a thin sintered silica sheet comprising:
applying a force to the sintered sheet of high-purity fused silica having a silica content of at least 99.9 mole % SiO₂ to form a flattened silica sheet, wherein the flattened silica sheet has an average warp that is less than the as-sintered average warp; and wherein the sintered silica sheet is above a glass transition temperature of the sintered glass sheet while the force is applied.

29. The method of claim 28, wherein the as-sintered average warp is greater than 1 mm, and the average warp of the flattened silica sheet is less than 1 mm.

30. The method of claim 28, wherein the sintered silica sheet is located between a lower plate and an upper plate during the applying, and the applied force includes weight of the upper plate, wherein the lower plate has an upper surface and the upper plate has a lower surface, wherein the Ra roughness of both the upper surface and the lower surface is greater than 500 nm, and wherein the upper and lower plates comprise silica.
